(19) United States
(12) Patent Application Publication
(10) Pub. No.: US 2017/0303564 A1
(43) Pub. Date: Oct. 26, 2017

(54) Method for Making Starch Pearl Ball

(71) Applicant: Chih-Chieh Chen, Kaohsiung City (TW)

(72) Inventor: Chih-Chieh Chen, Kaohsiung City (TW)

(21) Appl. No.: 15/133,273

(22) Filed: Apr. 20, 2016

(51) Int. Cl. A23L 2/52; A23L 2/385

(52) U.S. Cl. CPC A23L 2/52; A23L 2/385; A23V 2002/00

(57) ABSTRACT

A method includes provides native starch and modified starch which are mixed to form a body. Then, the body and the cement are treated by a conventional manufacturing method to make ungelatinized starch pearl balls. The ungelatinized starch pearl balls are treated by a boiled process during 5-30 minutes and are then treated by a heat soaked boiled process during 30-150 minutes to form gelatinized starch pearl balls. Then, the gelatinized starch pearl balls and a soaking liquid are filled into a package to perform a vacuum filling and seal packed process, so that the gelatinized starch pearl balls are soaked in the soaking liquid during a few hours. Then, the gelatinized starch pearl balls perform a quick freezing process to prevent the starch pearl balls from becoming aged and hardened. Thus, the starch pearl balls keep a chewy taste and have different flavors.

### BACKGROUND OF THE INVENTION

### 1. Field of the Invention

The present invention relates to a method for making a flavored starch pearl ball that keeps a chewy taste during a long period of time.

### 2. Description of the Related Art

Conventional starch pearl balls are made of cassava starch. When the starch pearl balls are filled into boiled water, the starch pearl balls are cooked to present a transparent state with a chewy taste. However, the conventional starch pearl balls become aged and hardened during a period of time, so that the conventional starch pearl balls cannot last a long time and easily lose the chewy taste when they are not eaten immediately.

### BRIEF SUMMARY OF THE INVENTION

The primary objective of the present invention is to provide a method that prevents the starch from becoming aged or hardened, so that the starch pearl balls can be frozen and keep a chewy taste during a long period of time.

In accordance with the present invention, there is provided a method for making a starch pearl ball, comprising a) providing stabilized modified starch, crosslinked modified starch or stabilized and crosslinked modified starch which are used independently or mixed together, or providing modified starch as a body; b) providing muscovado syrup, caramel syrup or waxground syrup to form a cement; c) mixing and stirring completely the body and the cement, with a mixture ratio of 65-80:35-20, and milling the body and the cement by a milling machine to form powder; d) treating the powder by a roller to perform a granulated process and performing a rounding process to form ungelatinized starch pearl balls; e) treating the ungelatinized starch pearl balls by a boiled process during 5-30 minutes, and then by a heat soaked boiled process during 30-150 minutes to form gelatinized starch pearl balls; f) filling the gelatinized starch pearl balls and a soaking liquid, with a mixture ratio of 8:2, into a package by a manual work or an automatically filling machine to perform a filling and seal packed process; g) performing a soaking process during 1-6 hours; and h) performing a quick freezing process to form a final product with starch pearl balls.

Preferably, the soaking liquid includes an extract that is selected from coffee, tea, herb or dried longan, or includes concentrate fruit juice and puree or vegetable juice and puree.

Preferably, the gelatinized starch pearl balls are soaked in the soaking liquid under various temperature, various atmospheric pressure, reduced pressure or vacuum.

Preferably, the cement is selected from caramel syrup or vegetable and fruit juice or plant extract, and is added with water and pigment to be mixed and stirred completely with the body.

In the present invention, the native starch and the modified starch are mixed to form a body. Then, the body and the cement are treated by a manufacturing method of a conventional starch pearl ball to make ungelatinized starch pearl balls each having a diameter of 0.3-1.2 cm. The native starch is selected from cassava, pachyrhizus, sago or potato. The modified starch includes stabilized modified starch, crosslinked modified starch or stabilized and crosslinked modified starch. The cement is selected from syrup, extract, juice, concentrate juice, puree and deionized water, hydrocolloid, pigment, and spice.

In the present invention, the ungelatinized starch pearl balls are treated by a boiled process during 5-30 minutes. Then, the ungelatinized starch pearl balls are treated by a heat soaked boiled process during 30-150 minutes to form gelatinized starch pearl balls. Then, the gelatinized starch pearl balls and a soaking liquid are filled into a package to perform a vacuum filling and seal packed process at a normal temperature, so that the gelatinized starch pearl balls are soaked in the soaking liquid during a few hours. The soaking liquid may be muscovado molasses, caramel syrup or waxground syrup. Alternatively, the soaking liquid may be concentrate fruit juice and puree or vegetable juice and puree. Alternatively, the soaking liquid may be an extract that is selected from coffee, tea, herb or dried longan. Thus, the starch pearl balls have various flavors by the soaking liquid.

In the present invention, the gelatinized starch pearl balls that have been soaked are delivered to a refrigeration device to perform a quick freezing process to form a final product with flavored starch pearl balls. When in use, the frozen package of the starch pearl balls thaws by microwaves or hot water so that the starch pearl balls can be eaten immediately. Thus, the starch pearl balls keep a chewy taste as if they were just cooked. In addition, the starch pearl balls have original flavors of the soaking liquid to satisfy the user's favor.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a method for making a starch pearl ball in accordance with the preferred embodiment of the present invention.

### DETAILED DESCRIPTION OF THE INVENTION

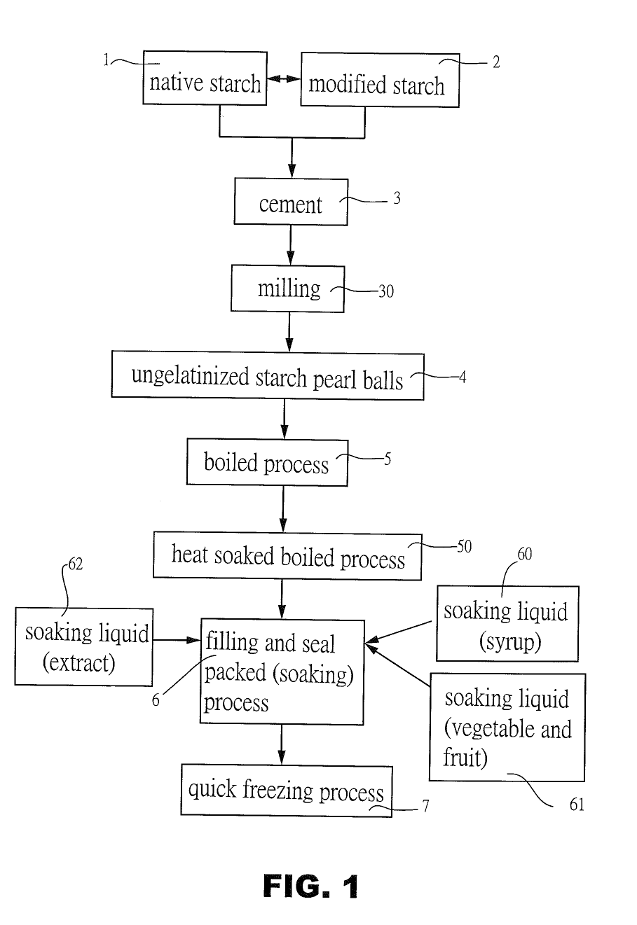

Referring to FIG. 1, a method for making a starch pearl ball in accordance with the preferred embodiment of the present invention comprises providing a staple. The staple includes a native starch 1 and a modified starch 2. The native starch 1 is selected from cassava, pachyrhizus, sago or potato. The modified starch 2 includes stabilized modified starch, crosslinked modified starch or stabilized and crosslinked modified starch. The stabilized modified starch is selected from acetylated starch, phosphate starch, hydroxypropyl starch, starch sodium succinate, and distarch glycerol. The crosslinked modified starch is selected from hydroxypropyl distarch phosphate, distarch phosphate, distarch glycerol. The stabilized and crosslinked modified starch is selected from acetylated distarch adipate, phosphated distarch phosphate, acetylated distarch phosphate, succinyl distarch glycerol and hydroxypropyl distarch glycerol. Then, a cement 3 is provided. The cement 3 is selected from syrup, extract, juice, concentrate juice, puree and deionized water, hydrocolloid, pigment, and spice. The hydrocolloid is selected from xanthan gum, guar gum, and sodium carboxymethyl cellulose.

The native starch 1 and the modified starch 2 are mixed to form a body. Then, the body and the cement 3 are mixed and stirred to form a lump. The mixture ratio of the body and the cement 3 is about 65-80:35-20. Then, the lump is milled by a milling machine during a milling process 30 to form powder. Then, the powder is treated by a conventional roller to perform a granulated process and is performed by a rounding process to form ungelatinized starch pearl balls 4. Preferably, the cement 3 uses caramel syrup and pigment added with water and is then mixed with the starch. Alternatively, the cement 3 uses vegetable and fruit juice and extract. Thus, the ungelatinized starch pearl balls 4 have different flavors by provision of the cement 3. Then, the ungelatinized starch pearl balls 4 are treated by a boiled process 5 during 5-30 minutes. Then, the ungelatinized starch pearl balls 4 are treated by a heat soaked boiled process 50 during 30-150 minutes to form gelatinized starch pearl balls. Then, the gelatinized starch pearl balls and a soaking liquid 60 are filled into a package by a manual work or an automatically filling machine to perform a filling and seal packed process 6, so as to go on a soaking process. The mixture ratio of the gelatinized starch pearl balls and the soaking liquid 60 are about 70-85:30-15. The soaking liquid 60 may be muscovado molasses, caramel syrup or waxground syrup. The soaking time is about 1-6 hours. The soaking process is performed at an atmospheric pressure or under a vacuum condition. Then, a quick freezing process 7 is performed to form a final product with flavored starch pearl balls.

In the filling and seal packed process 6, the soaking liquid 60 is replaced by a soaking liquid 61 which includes concentrate fruit juice and puree or vegetable juice and puree. Alternatively, the soaking liquid 60 is replaced by a soaking liquid 62 which includes an extract that is selected from coffee, tea, herb or dried longan. Thus, the starch pearl balls have various flavors.

The primary advantage of the present invention is in that, the starch pearl balls keep a chewy feature after thawing or defrosting by provision of the modified starch 2. In addition, the starch pearl balls have various flavors by the soaking process. Further, the starch pearl balls have been boiled and processed previously so that the starch pearl balls are edible immediately after thawing by microwaves or hot water without having to cook the starch pearl balls during a long period of time, and the user can eat the starch pearl balls easily and quickly. Further, the starch pearl balls are kept at a frozen state so that the starch pearl balls are preserved during a long time.

In the preferred embodiment of the present invention, the body of the starch pearl balls is selected from a hydroxypropyl etherification cassava starch, and the soaking liquid is selected from muscovado syrup. In fabrication, the hydroxypropyl etherification cassava starch serves as the body. Then, water, muscovado syrup, hydrocolloid and muscovado spice are mixed evenly to form the cement. Then, the body and the cement are mixed and stirred evenly to form a lump. The mixture ratio of the body and the cement is about 70:30. Then, the lump is milled to form powder. Then, the powder is treated by a roller to perform a granulated process, and is rolled successively to gradually become larger and bigger to form ungelatinized starch pearl balls each having a diameter of 1.0 centimeter. Then, the ungelatinized starch pearl balls are treated by a boiled process during 30 minutes. Then, the ungelatinized starch pearl balls are treated by a heat soaked boiled process during 60 minutes to form gelatinized starch pearl balls. Then, the gelatinized starch pearl balls are placed into a container. Then, the gelatinized starch pearl balls and the soaking liquid are mixed with a mixture ratio of 8:2, to perform a vacuum soaking process during 1 hour. Then, a quantifying process is performed. Then, a seal packed process is performed. Then, a freezing process is performed to form a final product with starch pearl balls. After the product is made during a week, the starch pearl balls are edible after thawing by microwaves or hot water so that the user can taste and comment on the features of the starch pearl balls.

In a first comparison example of the present invention, the body of the starch pearl balls is selected from a cassava starch, and the soaking liquid is selected from muscovado syrup. In fabrication, the cassava starch serves as the body. Then, water, muscovado syrup, hydrocolloid and muscovado spice are mixed evenly to form the cement. Then, the body and the cement are mixed and stirred evenly to form a lump. The mixture ratio of the body and the cement is about 70:30. Then, the lump is treated by a roller to perform a granulated process, to gradually become larger and bigger to form ungelatinized starch pearl balls each having a diameter of 0.5 centimeter. Then, the ungelatinized starch pearl balls are treated by a boiled process during 15 minutes. Then, the ungelatinized starch pearl balls are treated by a heat soaked boiled process during 15 minutes to form gelatinized starch pearl balls. Then, the gelatinized starch pearl balls are placed into a container. Then, the gelatinized starch pearl balls and the soaking liquid are mixed with a mixture ratio of 8:2, to perform a soaking process during 2 hour. Then, a quantifying process is performed. Then, a seal packed process is performed. Then, a freezing process is performed to form a final product with starch pearl balls. After the product is made during a week, the starch pearl balls are edible after thawing by microwaves or hot water so that the user can taste and comment on the features of the starch pearl balls.

In a second comparison example of the present invention, the body of the starch pearl balls is selected from a cassava starch, and the soaking liquid is selected from muscovado syrup. In fabrication, the cassava starch serves as the body. Then, water, muscovado syrup, hydrocolloid and muscovado spice are mixed evenly to form the cement. Then, the body and the cement are mixed and stirred evenly to form a lump. The mixture ratio of the body and the cement is about 70:30. Then, the lump is treated by a roller to perform a granulated process, to gradually become larger and bigger to form ungelatinized starch pearl balls each having a diameter of 1.0 centimeter. Then, the ungelatinized starch pearl balls are treated by a boiled process during 30 minutes. Then, the ungelatinized starch pearl balls are treated by a heat soaked boiled process during 30 minutes to form gelatinized starch pearl balls. Then, the gelatinized starch pearl balls are placed into a container. Then, the gelatinized starch pearl balls and the soaking liquid are mixed with a mixture ratio of 8:2, to perform a soaking process during 2 hour. Then, a quantifying process is performed. Then, a seal packed process is performed. Then, a freezing process is performed to form a final product with starch pearl balls. After the product is made during a week, the starch pearl balls are edible after thawing by microwaves or hot water so that the user can taste and comment on the features of the starch pearl balls.

In a third comparison example of the present invention, the body of the starch pearl balls is selected from a cassava starch, and the soaking liquid is selected from muscovado syrup. In fabrication, the cassava starch serves as the body. Then, water, muscovado syrup, hydrocolloid and muscovado spice are mixed evenly to form the cement. Then, the body and the cement are mixed and stirred evenly to form a lump. The mixture ratio of the body and the cement is about 70:30. Then, the lump is treated by a roller to perform a granulated process, to gradually become larger and bigger to form ungelatinized starch pearl balls each having a diameter of 1.0 centimeter. Then, the ungelatinized starch pearl balls are treated by a boiled process during 30 minutes. Then, the ungelatinized starch pearl balls are treated by a heat soaked boiled process during 30 minutes to form gelatinized starch pearl balls. Then, the gelatinized starch pearl balls are placed into a container. Then, the gelatinized starch pearl balls and the soaking liquid are mixed with a mixture ratio of 8:2, to perform a vacuum soaking process during 1 hour. Then, a quantifying process is performed. Then, a seal packed process is performed. Then, a freezing process is performed to form a final product with starch pearl balls. After the product is made during a week, the starch pearl balls are edible after thawing by microwaves or hot water so that the user can taste and comment on the features of the starch pearl balls.

In a four comparison example of the present invention, the body of the starch pearl balls is selected from a hydroxypropyl etherification cassava starch, and the soaking liquid is selected from muscovado syrup. In fabrication, the hydroxypropyl etherification cassava starch serves as the body. Then, water, muscovado syrup, hydrocolloid and muscovado spice are mixed evenly to form the cement. Then, the body and the cement are mixed and stirred evenly to form a lump. The mixture ratio of the body and the cement is about 70:30. Then, the lump is treated by a roller to perform a granulated process, to gradually become larger and bigger to form ungelatinized starch pearl balls each having a diameter of 1.0 centimeter. Then, the ungelatinized starch pearl balls are treated by a boiled process during 30 minutes. Then, the ungelatinized starch pearl balls are treated by a heat soaked boiled process during 30 minutes to form gelatinized starch pearl balls. Then, the gelatinized starch pearl balls are placed into a container. Then, the gelatinized starch pearl balls and the soaking liquid are mixed with a mixture ratio of 8:2, to perform a soaking process during 1 hour. Then, a quantifying process is performed. Then, a seal packed process is performed. Then, a freezing process is performed to form a final product with starch pearl balls. After the product is made during a week, the starch pearl balls are edible after thawing by microwaves or hot water so that the user can taste and comment on the features of the starch pearl balls. A table of the comment is described as follows.

| | After soaking | | | After thawing | | |
|---|---|---|---|---|---|---|
| | Color | flavor | taste | color | flavor | taste |
| preferred | ⊚ | ⊚ | ⊚ | ⊚ | ⊚ | ⊚ |
| embodiment | | | | | | |
| first | ⊚ | ⊚ | ⊚ | ⊚ | ⊚ | ◯ |
| example | | | | | | |
| second | ⊚ | ⊚ | ◯ | ⊚ | ⊚ | ◯ |
| example | | | | | | |
| third | ⊚ | ◯ | ⊚ | ⊚ | ◯ | ◯ |
| example | | | | | | |
| fourth | ◯ | ◯ | ⊚ | ◯ | ◯ | ⊚ |
| example | | | | | | |

It is to be noted that, the starch pearl balls after soaking and the starch pearl balls after thawing are placed in hot water of 95° C., or thaw by microwaves and are then added with cold milk, and ten tasters are selected to evaluate the starch pearl balls.

⊚: indicating that the product is good
◯: indicating that the product is normal

X: indicating that the product is bad

It is clear from the above table that, the modified starch 2 is combined with the cement 3 to produce the ungelatinized starch pearl balls 4. The ungelatinized starch pearl balls 4 then perform a boiled process 5 and a heat soaked boiled process 50 to form the gelatinized starch pearl balls. The gelatinized starch pearl balls are then soaked, packed and frozen. Thus, the gelatinized starch pearl balls keep a chewy feature after thawing, and taste like the gelatinized starch pearl balls are just cooked and soaked.

In conclusion, the modified starch 2 is used independently as the body or added into the native starch 1 to form the body which is combined with the cement 3 to produce the ungelatinized starch pearl balls 4. The ungelatinized starch pearl balls 4 then perform a boiled process 5 and a heat soaked boiled process 50 to form the gelatinized starch pearl balls. The gelatinized starch pearl balls are then soaked in different soaking liquids. The gelatinized starch pearl balls are then quantified, packed and frozen quickly. Thus, the gelatinized starch pearl balls keep a chewy feature after thawing, and the user has a feeling that the gelatinized starch pearl balls are just cooked and soaked without having a sensation of aged and hardened starch.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for making a starch pearl ball, comprising:
a) providing stabilized modified starch, crosslinked modified starch or stabilized and crosslinked modified starch which are used independently or mixed together, or providing modified starch as a body;
b) providing muscovado syrup, caramel syrup or waxground syrup to form a cement;
c) mixing and stirring completely the body and the cement, with a mixture ratio of 65-80:35-20, and milling the body and the cement by a milling machine to form powder;
d) treating the powder by a roller to perform a granulated process and performing a rounding process to form ungelatinized starch pearl balls;
e) treating the ungelatinized starch pearl balls by a boiled process during 5-30 minutes, and then by a heat soaked boiled process during 30-150 minutes to form gelatinized starch pearl balls;
f) filling the gelatinized starch pearl balls and a soaking liquid, with a mixture ratio of 8:2, into a package by a manual work or an automatically filling machine to perform a filling and seal packed process;
g) performing a soaking process during 1-6 hours; and
h) performing a quick freezing process to form a final product with starch pearl balls.

2. The method for making a starch pearl ball of claim 1, wherein the soaking liquid includes an extract that is selected from coffee, tea, herb or dried longan, or includes concentrate fruit juice and puree or vegetable juice and puree.

3. The method for making a starch pearl ball of claim 1, wherein the gelatinized starch pearl balls are soaked in the soaking liquid under various temperature, various atmospheric pressure, reduced pressure or vacuum.

4. The method for making a starch pearl ball of claim 1, wherein the cement is selected from caramel syrup or vegetable and fruit juice or plant extract, and is added with water and pigment to be mixed and stirred completely with the body.
